(19) United States
(12) Patent Application Publication
(10) Pub. No.: US 2006/0261170 A1
(43) Pub. Date: Nov. 23, 2006

(54) Card holder

(76) Inventors: Kenneth L. Mooney, Seattle, WA (US); Nathan Long, Dallas, TX (US)

Correspondence Address: Norris, Braden, Melton & Gregersen, P.L.L.C., Suite 305, 1901 Pennsylvania Ave., N.W., Washington, DC, 20006, US

(21) Appl. No.: 11/334,728

(22) Filed: Jan. 18, 2006

Related U.S. Application Data
(60) Provisional application No. 60/644,831, filed on Jan. 18, 2005.

(51) Int. Cl. G06K 7/00; G06K 5/00

(52) U.S. Cl. 235/486; 235/380

(57) ABSTRACT

A container is provided which includes a holder for a prepaid card, credit card, debit card and the like, for use in connection with purchasing products with a business establishment.

### CROSS-REFERENCE TO RELATED APPLICATIONS

This application claims the benefit of provisional application 60/644,831 filed Jan. 18, 2005.

### BACKGROUND

Prepaid cards can provide an effective tool to promote the purchase of store merchandise. These cards are usually purchased with a selected value within a store and they are used to buy items in the store. Prepaid cards have particular usefulness in stores, such as coffee and donut shops, for the frequent purchase of food and beverage items being sold in these stores. Use of prepaid cards by a consumer can be advantageous to a merchant in that checkout times at the register can be reduced. Further, the purchase of these cards for a selected value, in effect, extends credit to a store until such time as the card is fully used.

From a marketing perspective, prepaid cards, can serve as vehicles to promote brand awareness and distribution. However, an existing challenge for merchants with prepaid cards concerns increasing prepaid card acceptance and use within the merchant establishment. For instance, it would be very desirous for a chain store to develop the use of its prepaid card and its brand identity to the extent and manner of that associated with some well-know credit cards. Some credit cards have been tied to symbols of status, identity or self-importance (e.g., gold cards, premium cards, etc). When certain credit cards are used for purchase, some view this event as the delivery of a symbolic message as well. However, use of prepaid cards in coffee and donut shops can present some unique problems in that frequent use of the prepaid card can also entail a certain amount of inconvenience in accessing the card from a wallet or purse.

A need exists to allow a consumer a means by which to conveniently access a prepaid card, encourage frequent use of a merchant's prepaid card and provide a merchant an opportunity to increase brand awareness so as encourage distribution of the prepaid card.

### BRIEF DESCRIPTION OF THE DRAWINGS

FIG. 1a illustrates a side view of a fanciful beverage holder 2 having a lid, a handle and base.

FIG. 1b illustrates a top view of a prepaid card inserted into a holder shown as a slot in a handle.

FIG. 1c illustrates a top view of a prepaid card inserted into a holder shown as a slot in a base.

FIG. 2 illustrates a top view of a prepaid card which can include a magnetic stripe or bar code, for the purpose of being scanned by a register scanner, which is prominently displayed through slot on the beverage holder.

FIG. 3a illustrates a side view of a fanciful beverage holder having lid, a base and grooved sides to facilitate a handgrip of the cup.

FIG. 3b illustrates a top view of prepaid card inserted into a holder shown as a slot in a base.

FIG. 4a illustrates a side view of a fanciful beverage holder having a lid, a handle 6 and a base.

FIG. 4b illustrates a top view of a prepaid card inserted into a holder shown as a slot in handle.

FIG. 4c illustrates a top view of prepaid card inserted into a holder shown as a slot in a base.

Applicable reference numerals have been carried forward.

### DETAILED DESCRIPTION

The foregoing problems/needs are addressed by providing an article, which is commonly used in a store, that includes a holder compartment, slot, etc. for holding a prepaid card.

In one aspect of a preferred embodiment, the card is preferably exposed in its holder in order to readily accommodate electronic scanning.

In another aspect of a preferred embodiment, a beverage container is constructed so as to include a holder for a prepaid card.

In yet another aspect of a preferred embodiment the beverage container includes multiple locations thereon for the holder compartment for storage of the prepaid card.

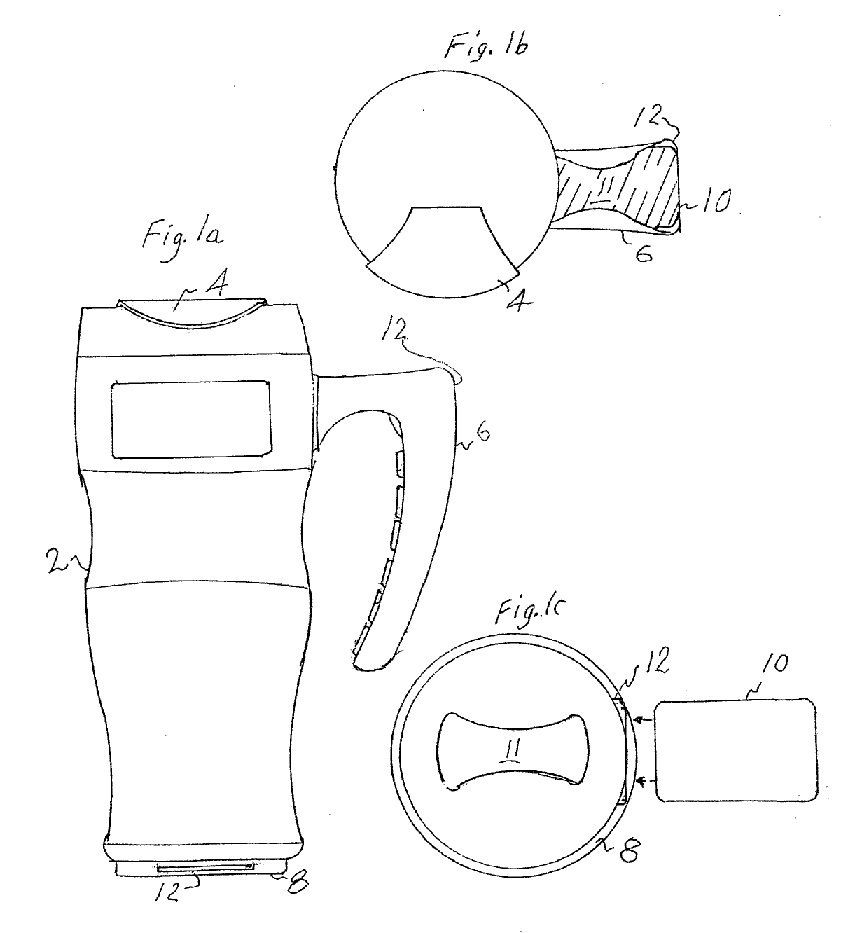

FIG. 1a illustrates a side view of beverage holder 2 having lid 4, handle 6 and base 8. Handle 6 and base 8 can include a slot 12 for insertion of a prepaid card. Beverage holder 2 is shaped with curved waist to facilitate a handgrip in addition to supporting a grip, by hand, of handle 6. A brand or product name is preferably affixed or inscribed at any location on holder 2 as shown at space 11.

FIG. 1b illustrates a top view of a prepaid card 10 inserted into a holder shown as a slot 12 in handle 6.

FIG. 1c illustrates a top view of a prepaid card 10 inserted into a holder shown as a slot 12 in base 8.

The prepaid cards shown in FIGS. 1b and 1c can be inserted into slots 12 such that the brand name of the merchant is prominently displayed.

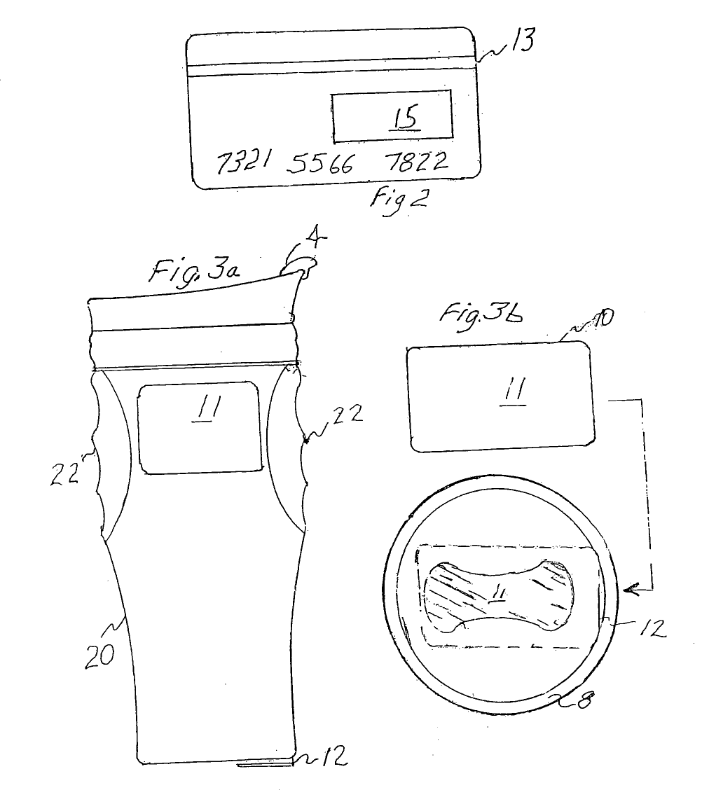

In an alternative embodiment, card 10 can represent a prepaid care which includes a magnetic stripe or bar code (e.g a universal product code (UPC)), for being scanned by a register scanner such as a magnetic stripe reader or bar code reader, which is prominently displayed through slot 12, as shown in the top view of card 10, illustrated in FIG. 2. Card 10 rather than being made in a similar fashion to an ordinary credit card, can include a magnetic stripe (or alternatively a bar code) on the face of the card rather than being on the back of the card on the side of the card opposite from the brand name display. Card 10 shown in FIG. 2 facilitates easy swiping of card 10 by a scanner (not shown) while serving a purpose of advertising by prominently displaying a merchant or product brand name.

FIG. 3a illustrates a side view of beverage holder 20 having lid 4, base 8 and grooved sides 22 to facilitate a hand grip of the cup. Base 8 can include a slot 12 for insertion of a prepaid card. A brand or product name is preferably affixed or inscribed at any location on holder 20 as shown at space 11.

FIG. 3b illustrates a top view of card 10 inserted into a holder shown as a slot 12 in base 8.

Card 10, which can be prepaid, is shown in FIG. 3b as being inserted into slot 12 such that the brand name of the merchant is prominently displayed. Alternatively, card 10 as shown in FIG. 2 can be used for insertion into slot 12 so as to accommodate scanning while prominently advertising brand or product names.

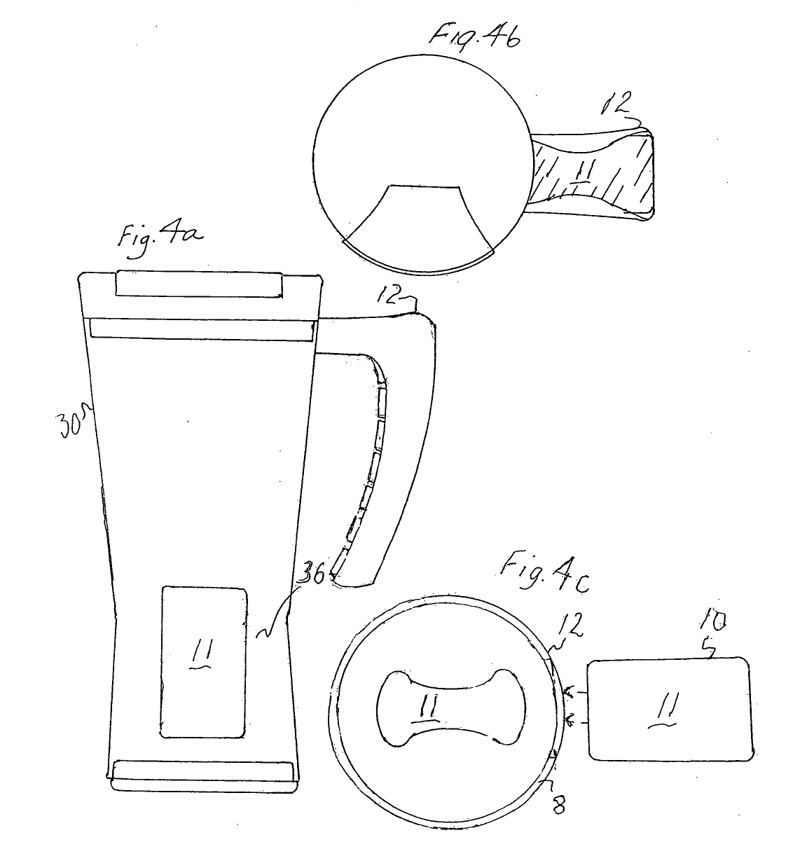

FIG. 4a illustrates a side view of beverage holder 30 having lid 4, handle 6 and base 8. Handle 6, base 8, can include a slot 12 for insertion of a prepaid card. Additionally, beverage holder 30 can include a clear sleeve 36, preferably made of a clear polymer material, for insertion attached to the holder, located between lid 4 ands base 8. Beverage holder 30 is shown with a smooth outer surface to accommodate the attachment of sleeve 36 thereto. A brand or product name is preferably affixed or inscribed at any location on holder 30 as shown at space 11.

FIG. 4b illustrates a top view of card 10 inserted into a holder shown as a slot 12 in handle 6.

FIG. 4c illustrates a top view of prepaid card 10 inserted into a holder shown as a slot 12 in base 8.

The cards shown in FIGS. 4a, 4b and 4c can represent prepaid cards and they can be inserted into respective slots 12 and sleeve 36 such that the brand name of the merchant is prominently displayed. Alternatively, card 10 as shown in FIG. 2 can be used for insertion into slot 12 so as to accommodate scanning while prominently advertising brand or product names.

In yet another embodiment, card 10 in FIG. 4c can represent a flash memory. As media centers become more prevalent, downloading of content such as audio and video including music, news, etc. will become more common. Typically, media centers offer the opportunity for customers to access high speed Internet and to compile or burn CDs or for downloading into a digital device, e.g. Apple® iPod®. In one aspect, card 10 is a flash memory stick for insertion into sleeve 36 which is representative of pouch for carrying card 10. The flash memory represented by card 10 is contemplated as having other shapes, e.g. sphere, bar, etc. that can be readily handled. As flash memory becomes cheaper, it is further contemplated that card 10 of suitably small enough capacity can be given away with a fee charged at the register for downloading music, videos, etc. Alternatively, promotions can be carried out using the memory stick of card 10. For instance, one free download of music could be given away in a coffee shop for every purchase of 2 refills of coffee and a pastry.

The foregoing description supports a method of conducting business whereby prepaid cards, credit cards and the like are contained and prominently displayed within articles such as vessels (e.g., cups, glasses and the like), used within a particular business. The method of conducting business can also include the use of a prepaid card, debit card and the like which includes a magnetic stripe or bar code, for being scanned by a register scanner, which is prominently displayed through a slot, sleeve or the like. The prepaid card, credit card, etc., rather than being made in a similar fashion to an ordinary credit card, can include a magnetic stripe (or alternatively a bar code) on the face of the card rather than being on the back of the card on the side of the card opposite from the brand name display. Construction of the card in this manner facilitates the prominent display and easy storage of the card for use in article used in a particular business.

The business methods contemplated include using the cards in combination with beverage holders to carry out promotions. For instance, perhaps a free beverage refill can be secured upon using the card a number of times, e.g. five times.

It is calculated that the foregoing described invention in its various embodiments will create symbols of status, identity or self-importance through use of the card as used together with its holder. The shape of the beverage holder as described and shown herein can also serve to encourage this effect.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

We claim:

1. A beverage container including at least one holder for a card for conducting monetary transactions.

2. A beverage container as recited in claim 1 wherein said beverage container is selected from the group consisting of a mug, a coffee mug, a cup, and insulated cup, a pitcher and a carafe.

3. A beverage container as recited in claim 1 wherein said container is disposable.

4. A beverage container as recited in claim 1 wherein said monetary transactions include credit card transactions.

5. A beverage container as recited in claim 1 wherein said monetary transactions include debit card transactions.

6. A beverage container as recited in claim 1 wherein said at least one holder includes a slot for insertion of said card.

7. A beverage container as recited in claim 1 wherein said container includes a mouth and a base and wherein said holder is located on a side of said container between said mouth and base.

8. A beverage container as recited in claim 1 wherein said container includes a base and wherein said holder is located in said base.

9. A beverage container as recited in claim 1 wherein said card is selected from the group consisting of a credit card, a debit card, and a prepaid card.

10. A card for conducting monetary transactions, in connection with said card being removably secured to a beverage container including at least one holder for securing said card, said card including a magnetic stripe and primary card identification information on a common side of said card, said magnetic stripe and said primary card identification information being displayed while said card is being secured in said holder.

11. A card as recited in claim 10 wherein said card is selected from the group consisting of a credit card, a debit card and a prepaid card.

12. A card as recited in claim 10 wherein said primary card identification information includes a card number.

13. A card as recited in claim 10 wherein said primary identification information includes an account number.

14. A card as recited in claim 10 wherein said primary card identification information includes a name.

15. A card as recited in claim 10 wherein said magnetic stripe is capable of being scanned by a magnetic card reader while said card is secured within said at least one holder.

16. A card for conducting monetary transactions, in connection with said card being removably secured to a beverage container including at least one holder for securing said card, said card including a universal product code on a common side of said card, said universal product code and said primary card identification information being displayed while said card is being secured in said holder.

17. A card as recited in claim 16 wherein said universal product code is capable of being scanned by a bar code reader while said card is secured within said at least one holder.

18. A card as recited in claim 16 wherein said card is selected from the group consisting of a credit card, a debit card and a prepaid card.

19. A card as recited in claim 16 wherein said primary card identification information includes a card number.

20. A card as recited in claim 16 wherein said primary identification information includes an account number.

21. A card as recited in claim 16 wherein said primary card identification information includes a name.

22. A method of doing business comprising distributing articles used in connection with said business that contain at least one holder for securing a card for conducting monetary transactions.

23. A method of doing business as recited in claim 22 wherein said at least one container includes a business name displayed thereon.

24. A method of doing business as recited in claim 22 wherein said at least one container includes advertisement displayed thereon.

25. A method of doing business as recited in claim 22 wherein said card is selected from the group consisting of a credit card, a debit card and a prepaid card.

26. A beverage container including at least one holder for a memory for holding digital content.

27. A beverage container as recited in claim 26 wherein said memory is a flash memory.

28. A beverage container as recited in claim 27 wherein said memory is capable of holding digital content consisting of audio content, video content or a combination thereof.
